(19) United States
(12) Patent Application Publication
(10) Pub. No.: US 2019/0321793 A1
(43) Pub. Date: Oct. 24, 2019

(54) SYSTEMS AND METHODS FOR BLENDING MATERIALS

(71) Applicant: ALTRIA CLIENT SERVICES LLC, RICHMOND, VA (US)

(72) Inventor: Carl G. MILLER, Richmond, VA (US)

(21) Appl. No.: 15/960,371

(22) Filed: Apr. 23, 2018

(51) Int. Cl. B01F 9/06

(52) U.S. Cl. CPC B01F 9/06; B01F 2009/0063

(57) ABSTRACT

A flight assembly comprising a flight with a curved outer edge portion and a support supporting the flight at an acute angle with respect to a longitudinal axis of the flight assembly, wherein the curved outer edge portion when rotated about the longitudinal axis describes a cylinder. The flight assembly is configured to cooperate in a system for blending flowable solid materials, comprising a cylindrical drum body, a drum roller apparatus arranged support and rotate the cylindrical drum body at an angle of inclination and a flight assembly as previously described. Associated methods are also disclosed.

### FIELD

The present disclosure relates generally to systems and methods for blending materials.

### ENVIRONMENT

The present disclosure addresses an existing need to blend materials, including without limitation powdered ingredients into a generally homogeneous, uniformly blended mix in a manner which may be simple, consistent, and/or cost-efficient. Additionally, it would be desirable that a container may be readied for a blending operation with manipulation of only a few components.

### SUMMARY

An aspect of certain embodiments of the present disclosure provides a flight assembly comprising a flight comprising a curved outer edge portion, a support supporting the flight at an acute angle with respect to a longitudinal axis of the flight assembly, wherein the curved outer edge portion when rotated about the longitudinal axis describes a cylinder.

In various embodiments, the curved outer edge portion of the flight may be elliptical, the flight may be planar and/or the flight may have a constant width.

In some embodiments, the flight may be a first flight, and the flight assembly may further comprise a second flight comprising a curved outer edge portion. The first and second flights may be supported in a mutually complementary angular relation.

In some embodiments, the flight assembly may be located inside a container and wherein the first and second flights may be mutually arranged to provide an end-to-end symmetry such that the flight assembly may be operative regardless of which end of the flight assembly is located at a bottom of the container.

Another aspect of certain embodiments of the present disclosure provides a mixing drum, comprising a cylindrical drum body, a flight assembly within an interior of the cylindrical drum body, with the flight assembly comprising a flight comprising a curved outer edge portion, a support supporting the flight at an acute angle with respect to a longitudinal axis of the cylindrical drum body, wherein from a top view, a curvature of the curved outer edge portion of the flight is generally parallel to a curvature of an interior surface of the cylindrical drum body.

Still another aspect of certain embodiments of the present disclosure provides a system for blending materials, the system comprising a cylindrical drum body, a drum roller apparatus arranged and configured to support and rotate the cylindrical drum body at an angle of inclination with respect to the horizontal, and a flight assembly within an interior of the cylindrical drum body, with the flight assembly being configured as previously described above.

Yet another aspect of certain embodiments of the present disclosure provides a method of blending materials comprising opening a container, inserting a flight assembly into the container, with the flight assembly comprising a flight arranged such that upon insertion of the flight assembly into the container a lower section of the flight positions adjacent to or close to a lower end portion of the container and an upper section of the flight positions adjacent to or close to an upper end portion of the container, upon insertion of the flight assembly into the container a plane of the flight is disposed at an acute angle with respect to a longitudinal axis of the container, loading materials into the container, closing the container, and rotating the loaded container while maintaining the loaded container at an angle, such that as the container rotates the flight assembly rotates with the container, and such that during rotation, the lower section of the flight repetitively lifts a portion of the materials from the lower end portion of the container, the flight repetitively distributes lifted materials along an interior of the container, including by cascading lifted materials off an inner edge of the flight as lifted materials flow from the lower section of the flight toward the upper section of the flight, and the interior of the container repeatedly returns cascaded materials to the lower portion of the container.

Additional aspects are disclosed herein.

### BRIEF DESCRIPTION OF THE DRAWINGS

The forms disclosed herein are illustrated by way of example, and not by way of limitation, in the figures of the accompanying drawings and in which like reference numerals refer to similar elements and in which:

FIG. 1 is a perspective side view of a system for blending materials into a blended product constructed in accordance with an example embodiment of the present disclosure, with FIG. 1 including a cut-away section at a location along an example drum to partially show an example of a flight insert therein;

FIG. 2 is a side view of the container shown in FIG. 1, but in an upright orientation and with a flight insert shown in dashed lines, in accordance with an example embodiment;

FIG. 3 is a planar side view of a flight insert, as viewed in the direction of arrow III in FIG. 4, in accordance with an example embodiment;

FIG. 4 is a perspective view of a flight insert, in accordance with an example embodiment;

FIG. 5 is a planar top view of a flight insert as viewed in the direction of arrow V in FIG. 4, in accordance with an example embodiment;

FIG. 6 is a planar side view of a flight insert as viewed in the direction of arrow VI in FIG. 4, in accordance with an example embodiment;

FIG. 7A is a planar side view of an individual flight of the flight insert shown in FIG. 4, in accordance with an example embodiment;

FIG. 7B is an edge view of the individual flight shown in FIG. 7A, in accordance with an example embodiment;

FIGS. 8A-E show a method of blending in accordance with an example embodiment of the present disclosure including placement of a flight assembly into an opened container (FIG. 8A), adding dry blend components (FIG. 8B), closing the container (FIG. 8C), rotating the closed container at an incline (FIG. 8D), and opening the container to remove the flight assembly (FIG. 8E);

FIG. 9 is a cross-sectional side view representation of particle movement during blending operations within a container of a blending system, in accordance with an example embodiment;

FIG. 10 is an end view of an open container and an inserted flight assembly, as viewed in the direction of arrow X in FIG. 9 when the flight assembly and container are at a first rotational position, in accordance with an example embodiment;

FIG. 10A is a cross-sectional view of lower portions of a container and a flight assembly as shown in FIG. 10, as viewed in the direction of double arrow A-A in FIG. 2, in accordance with an example embodiment;

FIG. 10B is a cross-sectional view of middle portions of a container and a flight assembly as shown in FIG. 10, as viewed in the direction of double arrow B-B in FIG. 2, in accordance with an example embodiment;

FIG. 100 is a cross-sectional view of upper portions a container and a flight assembly as shown in FIG. 10, as viewed in the direction of double arrow C-C in FIG. 2, in accordance with an example embodiment;

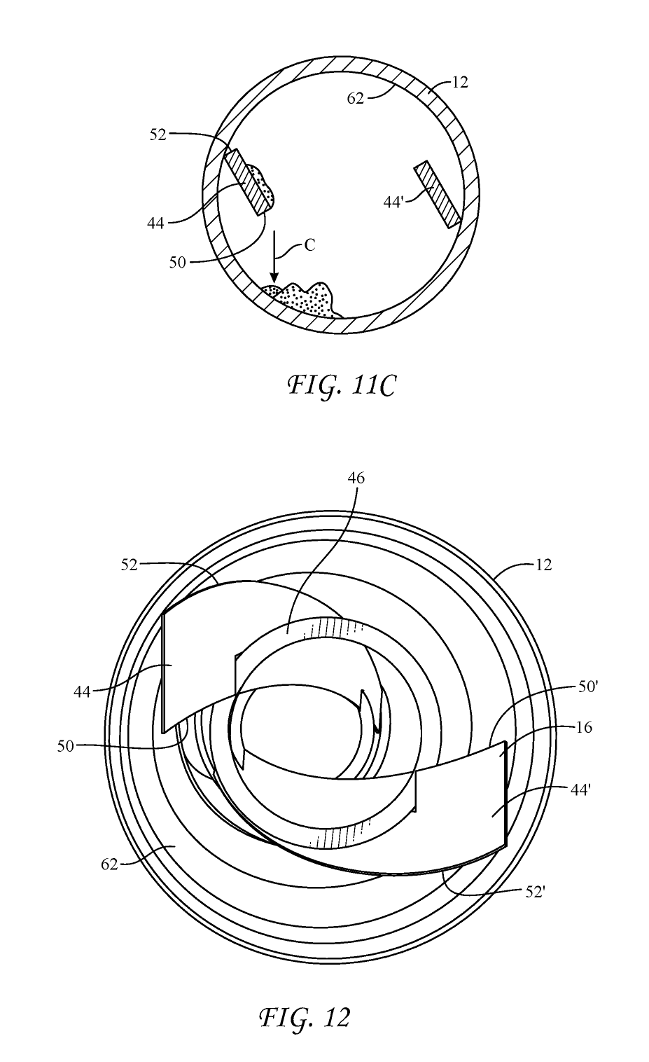

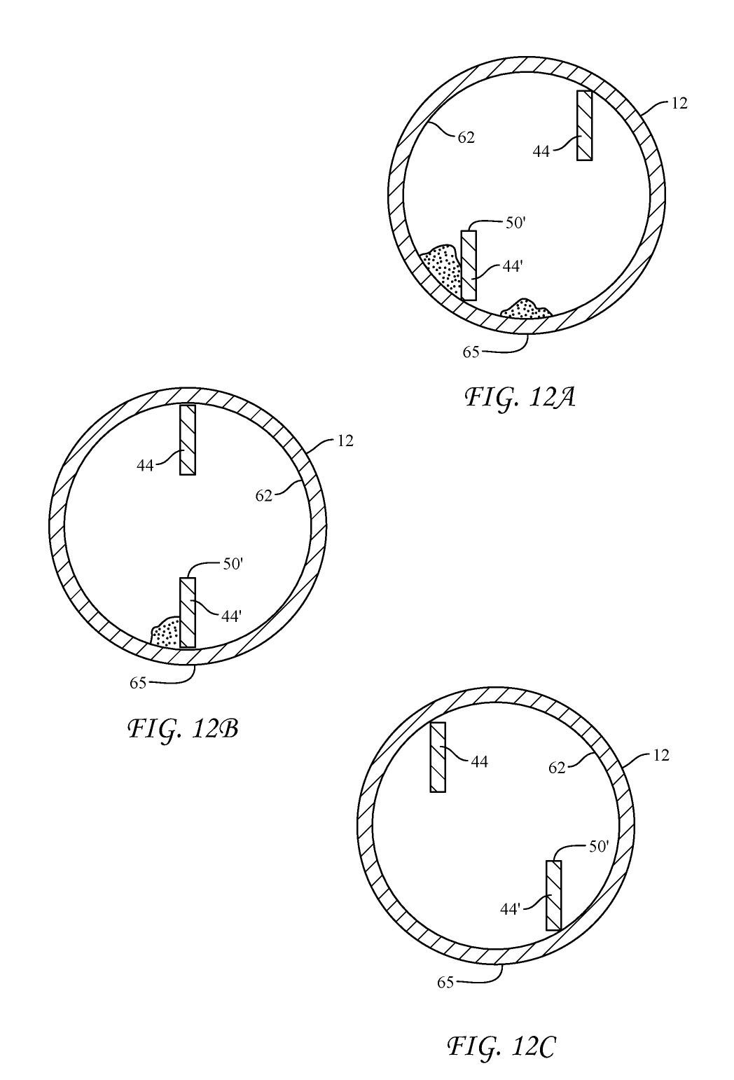

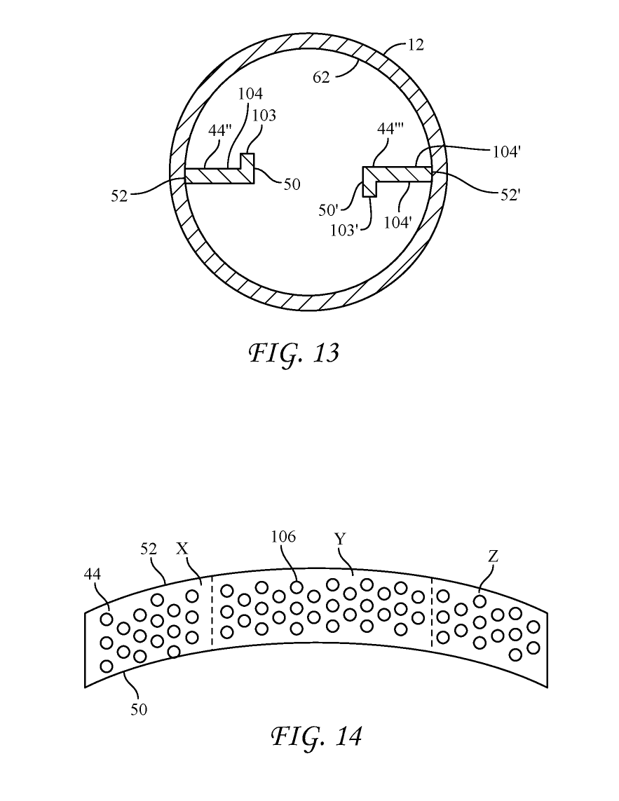

FIG. 11 is an end view of an open container and an inserted flight assembly, as viewed in the direction of arrow X in FIG. 9 when the flight assembly and container are at a second rotational position which is approximately 45° from the first position shown in FIG. 10, in accordance with an example embodiment;

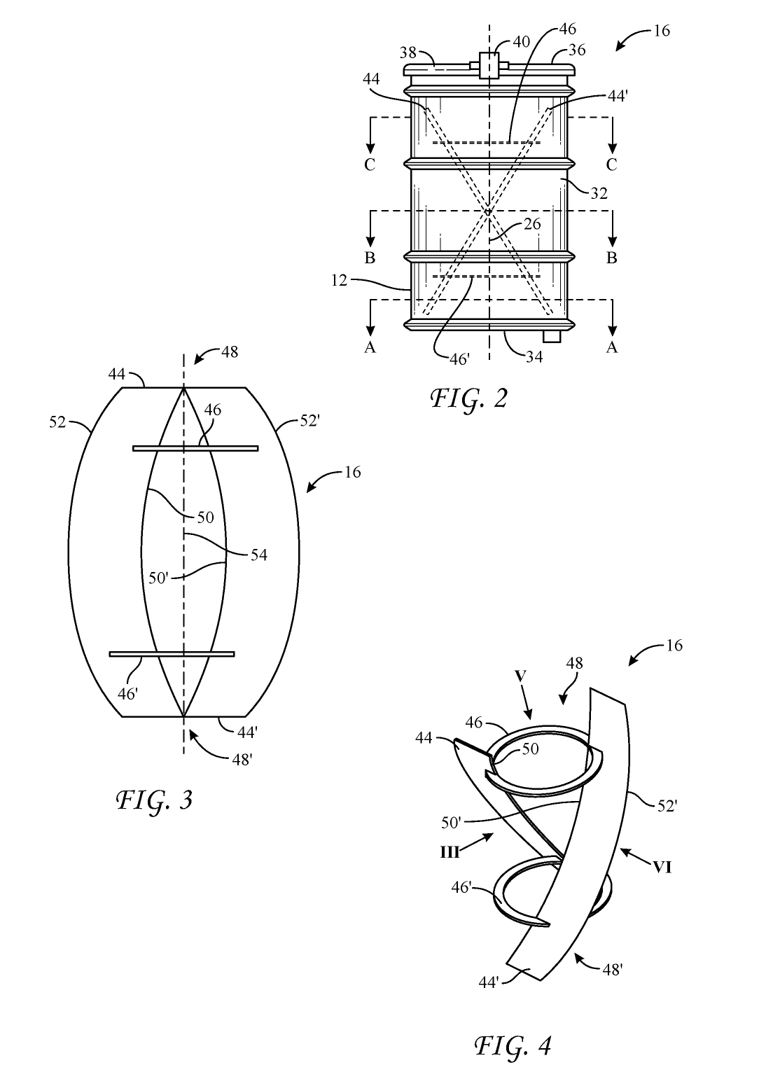

FIG. 11A is a cross-sectional view of lower portions of a container and a flight assembly as shown in FIG. 11, as viewed in the direction of double arrow A-A in FIG. 2, in accordance with an example embodiment;

FIG. 11B is a cross-sectional view of middle portions of a container and a flight assembly as shown in FIG. 11, as viewed in the direction of double arrow B-B in FIG. 2, in accordance with an example embodiment;

FIG. 11C is a cross-sectional view of upper portions of a container and a flight assembly as shown in FIG. 11, as viewed in the direction of double arrow C-C in FIG. 2, in accordance with an example embodiment;

FIG. 12 is an end view of an open container and an inserted flight assembly, as viewed in the direction of arrow X in FIG. 9 when the flight assembly and container are at a third rotational position which is approximately 45° from the second position shown in FIG. 11, in accordance with an example embodiment;

FIG. 12A is a cross-sectional view of lower portions of a container and a flight assembly as shown in FIG. 12, as viewed in the direction of double arrow A-A in FIG. 2, in accordance with an example embodiment;

FIG. 12B is a cross-sectional view of middle portions of a container and a flight assembly as shown in FIG. 12, as viewed in the direction of double arrow B-B in FIG. 2, in accordance with an example embodiment;

FIG. 12C is a cross-sectional view of upper portions of a container and a flight assembly as shown in FIG. 12, as viewed in the direction of double arrow C-C in FIG. 2, in accordance with an example embodiment;

FIG. 13 is a cross-sectional view of a container and flight assembly, as viewed in the direction of double arrow B-B in FIG. 2, wherein the flight assembly includes rimmed flights, according to another embodiment of the present disclosure; and

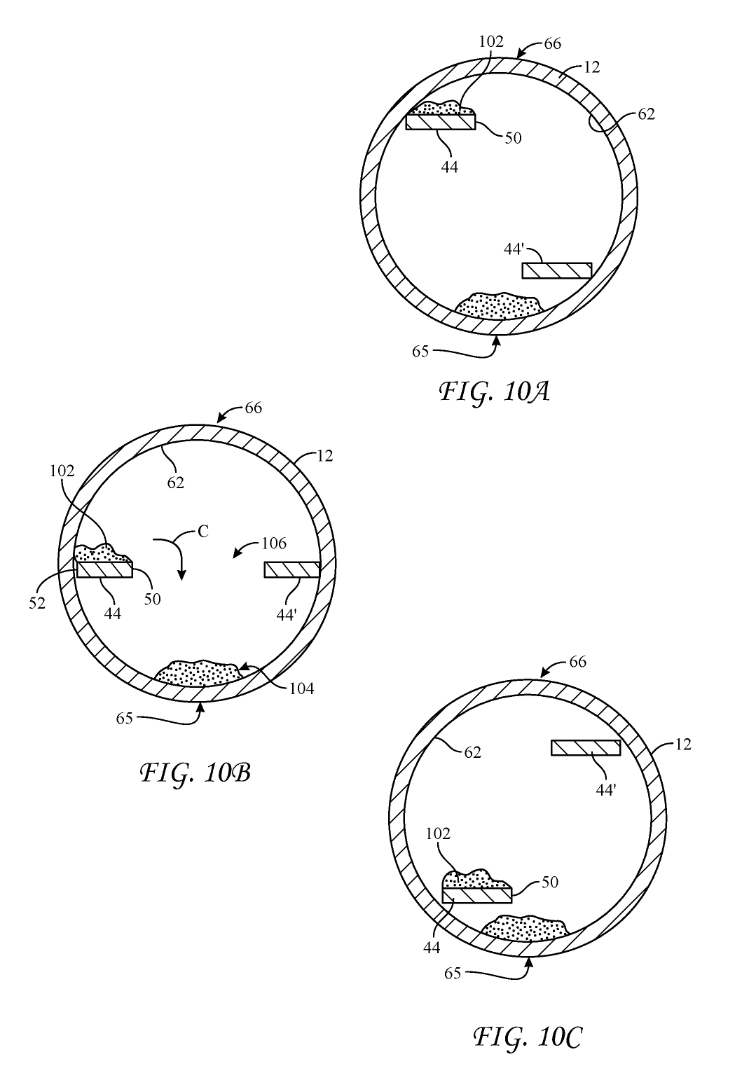

FIG. 14 is a planar top view of the flight shown in FIG. 7A, modified to include perforations, according to yet another embodiment the present disclosure.

### DETAILED DESCRIPTION

Each of the following terms: “includes,” “including,” “has,” “having,” “comprises,” and “comprising,” and, their linguistic or grammatical variants, derivatives, and/or conjugates, as used herein, means “including, but not limited to.”

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein.

Moreover, for stating or describing a numerical range, the phrase “in a range of between about a first numerical value and about a second numerical value,” is considered equivalent to, and means the same as, the phrase “in a range of from about a first numerical value to about a second numerical value,” and, thus, the two equivalently meaning phrases may be used interchangeably.

It is to be understood that the various forms disclosed herein are not limited in their application to the details of the order or sequence, and number, of steps or procedures, and sub-steps or sub-procedures, of operation or implementation of forms of the method or to the details of type, composition, construction, arrangement, order and number of the system, system sub-units, devices, assemblies, sub-assemblies, mechanisms, structures, components, elements, and configurations, and, peripheral equipment, utilities, accessories, and materials of forms of the system, set forth in the following illustrative description, accompanying drawings, and examples, unless otherwise specifically stated herein. The apparatus, systems and methods disclosed herein can be practiced or implemented according to various other alternative forms and in various other alternative ways.

It is also to be understood that all technical and scientific words, terms, and/or phrases, used herein throughout the present disclosure have either the identical or similar meaning as commonly understood by one of ordinary skill in the art, unless otherwise specifically defined or stated herein. Phraseology, terminology, and, notation, employed herein throughout the present disclosure are for the purpose of description and should not be regarded as limiting.

In the description which follows, reference is made to “particles” and “particle flows” which terms refer to blend components and the flow of the blend components, respectively, regardless of whether the blend components are specifically in the form of particles, granules, powders, beads, capsules, micro-capsules, nodules, fibers, fibrils, nano-particles and/or some other form, whether it be large and/or small in size.

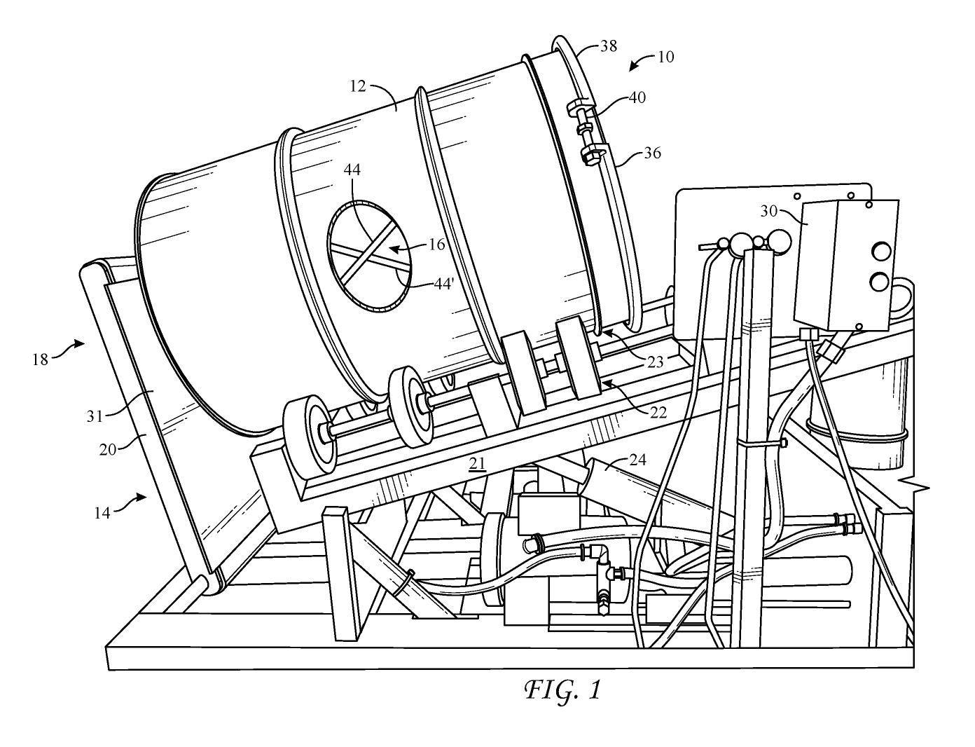

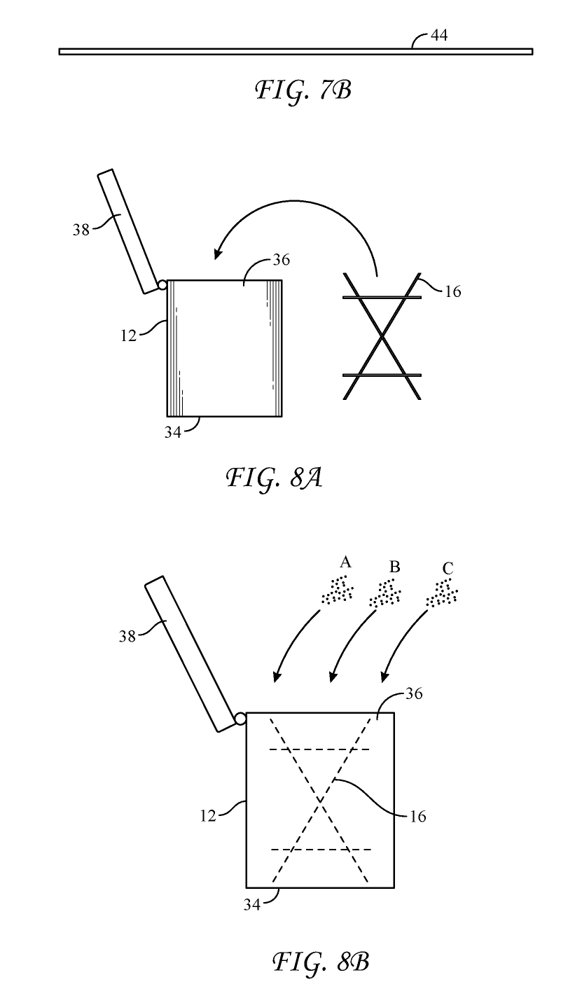

Referring now to FIG. 1, the present disclosure provides a system 10 for blending two or more dry blending components (ingredients). In an example embodiment, the system 10 may comprise a container 12, a drum roller apparatus 14 and a flight assembly 16. In FIG. 1, the flight assembly 16 is shown as having already been inserted into the container 12, and the container 12 has already been closed. An example embodiment of the flight assembly 16 is only partially visible in FIG. 1 via the cut-away section and is further shown FIG. 4.

In an example embodiment, the drum roller apparatus 14 may comprise an L shaped frame 18 with a base portion 20 and a longer frame member 21. In some embodiments, the L shaped frame 18 may be pivotal between an upright position (not shown) and an inclined position (an example of an inclined position is shown in FIG. 1; any other positions may be used). When at the upright position, the base portion 20 of the frame 18 may be disposed horizontally so as to facilitate loading of the container 12 upon the base portion 20. At this time, the container 12 may be positioned adjacent first and second sets of rollers 22 and 23 that may be disposed along opposing sides of the longer frame member 21. One or both of the sets of rollers 22 and 23 may be driven. A hydraulic sub-system 24 may be configured to pivot the L shaped frame 18 from an upright position to one or more inclined positions. At an example inclined position, longitudinal axis 26 of the container 12 is inclined at a predetermined angle such as, by way of non-limiting example, approximately 15° to the horizontal (if desired, any other angle between 0° and 90° may be used). At the inclined position, the container 12 may receive both rotational support and rotational drive from the sets drive rollers 22 and/or 23. The sets of drive rollers 22 and 23 are spaced apart such that they cradle the container 12 at mutually spaced, lower side portions of a container 12. During a blending operation, one or more of the drive rollers 22 and 23 may be rotated at a common rate and a common rotational direction so as to rotationally drive the container 12. In some embodiments, one or more of the drive rollers 22 and 23 may be under the control of a suitable drive motor and a suitable controller 30. A suitable commercially available drum-rolling mixer may be utilized. Such drum rollers may be modified to include a low-friction plate and/or a rotating plate 31 at the base portion 20 so that the container 12 may more easily rotate against base portion 20. The drum-rolling mixer may be further modified to include a suitable stop to consistently place the drum 12 at a desired angle of inclination from one mixing operation to another.

In some example embodiments, the container 12 may be a standard 55 gallon drum, but any other container sizes may be used. In some example embodiments, the controller 30 may be configured to rotate the container 12 in the range of about 5 revolutions per minute to about 15 revolutions per minute or more, and for a duration in the range of 3 minutes to about 15 minutes or more. Any other number of revolutions per minute, or time durations may be used.

In further embodiments, the drum roller apparatus 14 may be installed at a fixed location of a production facility or instead, may be arranged on wheels or a skid or the like to be moved from one location to another depending on need. In further embodiments, the container 12 may be small and manageable, and the L shaped frame 18 of drum roller apparatus 14 may be fixed in the inclined position.

Referring now to FIGS. 1 and 2, in certain example embodiments, the container 12 may comprise a drum body 32 having a closed bottom end portion 34 and a closable upper end portion 36. The closable upper end portion 36 may include a lid 38 that seals upon tightening of a circumferential clamp 40. It is envisioned that other arrangements to open and close the upper end portion 36 of the container 12 may be utilized instead, such as a threaded lid or other suitable mechanical convenience.

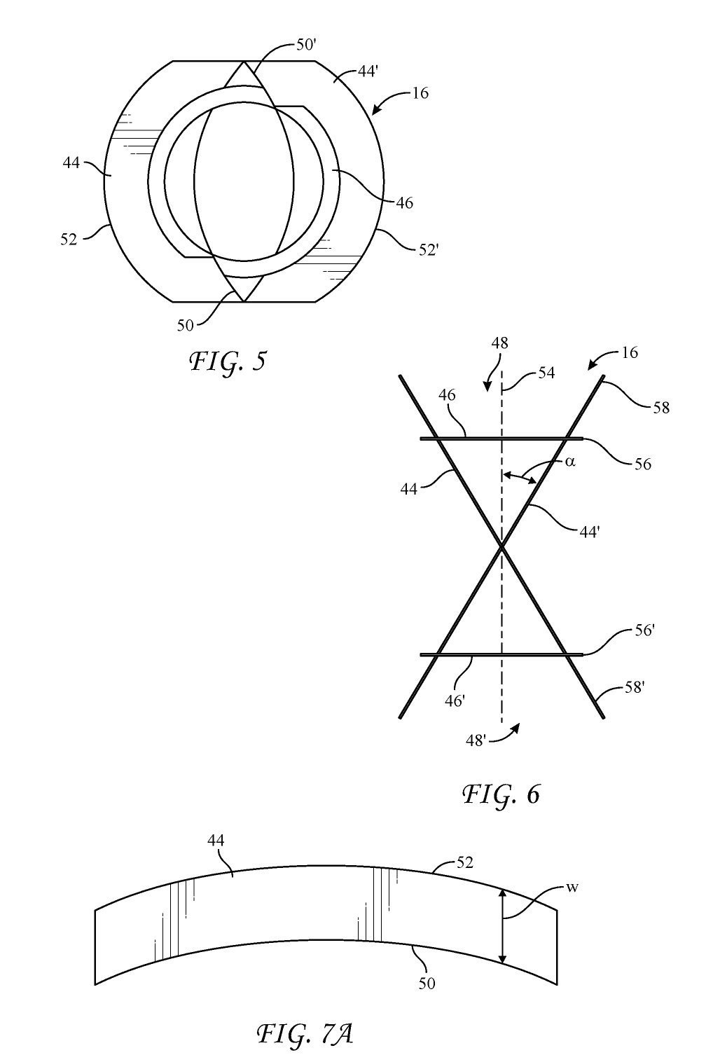

Referring now to FIGS. 3 and 4, according to an example embodiment, the flight assembly 16 of the blending system 10 may include one or more flights 44, 44′, which in an embodiment are connected by first and second rings 46, 46′. In some embodiments, each ring 46, 46′ may be spaced from a respective end 48, 48′ of the flight assembly 16 and may be attached by welding, brazing or other suitable method or convenience to the respective locations around or adjacent to inner edges 50, 50′ of the flights 44, 44′. Attachment of the rings 46, 46′ at said locations may minimize interference between the rings 46, 46′ and the desired particle flow along the flights 44, 44′ during operation of the blending system 10. Alternatively, the first and second rings 46, 46′ may be attached through middle sections or through the outer edge portions of the flights 44, 44′.

Referring now to FIGS. 4, 6 and 9, according to an example embodiment, a flight assembly 16 may be rotated into a position where flights 44, 44′ appear on edge and the planes of the flights 44, 44′ appear to cross at an intermediate location along the flights 44, 44′. In some embodiments, each of the flights 44, 44′ may be disposed at a flight angle α relative to a longitudinal axis 54 of the flight assembly 16. In some embodiments, the flight angle α may be greater than the angle of inclination of the drum roller apparatus. In example embodiments, the flights 44, 44′ may rotate (together with the container 12) through a position where one of the flights 44, 44′ is inclined downwardly in the direction from the closed, bottom end portion 34 of the container 12 toward the opposite, upper end portion 36 of the container. By way of non-limiting example, if the angle of inclination of the drum roller apparatus 14 is approximately 15 degrees, the flight angle α of the flight assembly 16 may be in the range of about 25 to about 35 degrees. Any other angles between 0 to 90 degrees may be used for the angle of inclination of the drum, or for the flight angle α. If desired, the flight angles α may be equal to or less than the angle of inclination of the drum roller apparatus. In some embodiments, each flight may be disposed at a different flight angle α relative to the longitudinal axis 54.

Still referring to FIGS. 4, 6 and 9, in regard to the present embodiment, whereas the first flight 44 may be inclined downwardly by the flight angle α, the other, second flight 44′ may be inclined upwardly at the flight angle α, and accordingly the flights 44, 44′ may be in a complementary relation to one another.

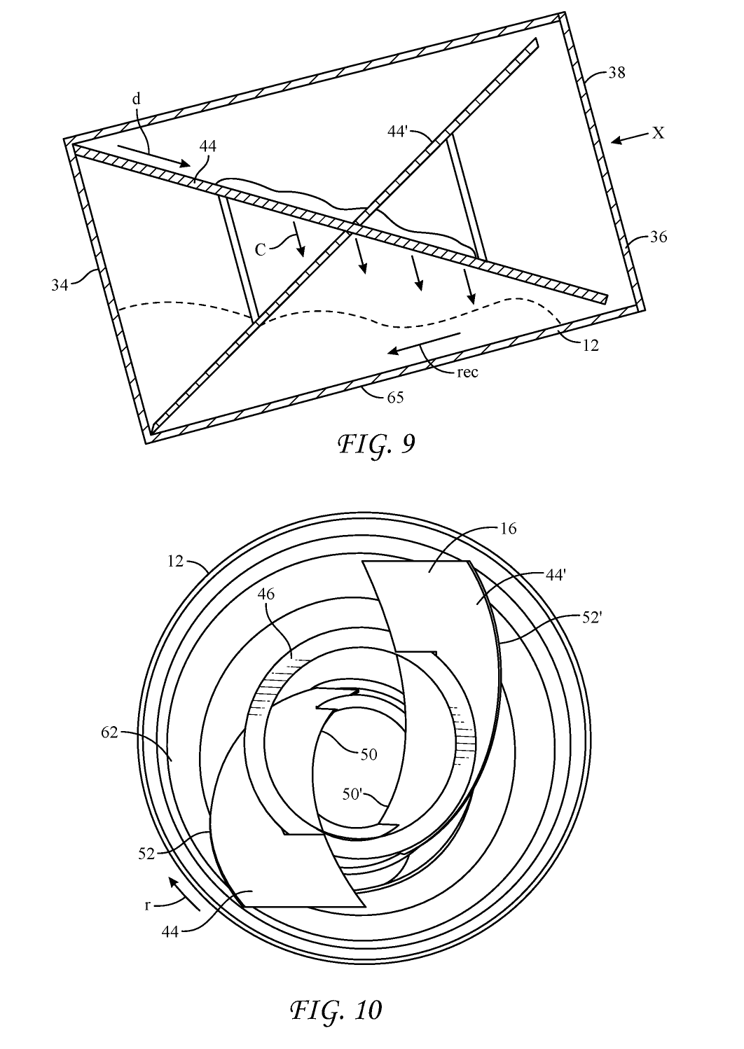

Referring particularly to FIG. 6, in some example embodiments the outer radial extent 56, 56′ of the rings 46, 46′, respectively, may be less than the outer radial extent 58, 58′ of the flights 44, 44′, respectively, which arrangement may minimize interference between the rings 46, 46′ and recirculating flows of particles along the interior of the container 12 during operation of the blending system 10.

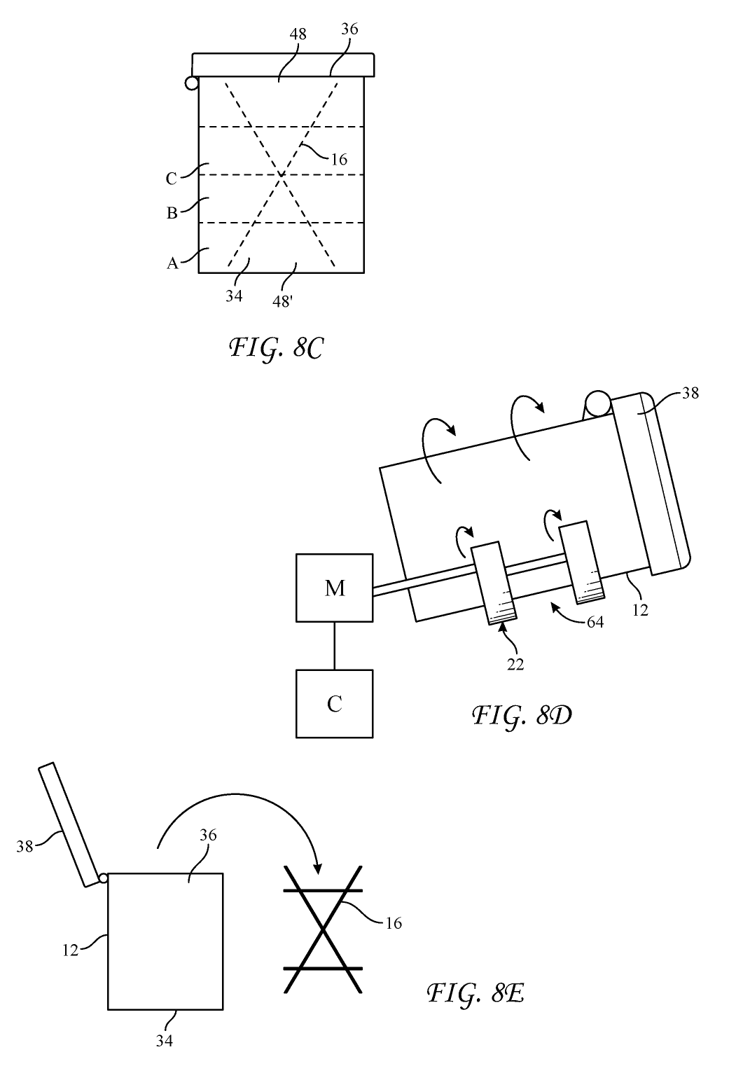

Referring now to FIGS. 5, 7A and 10, in some example embodiments, each flight 44, 44′ may be entirely planar and may have outer edge 52, 52′. In some embodiments, the outer edges may conform to an interior surface 62 of the container 12. The container 12 may have a cylindrical interior surface 62, in which case, the outer edges 52, 52′ of the flights 44, 44′, respectively, may be elliptical. Other shapes may be used. In some embodiments, sufficient clearance may be provided between the outer edges 52, 52′ of the flights 44, 44′ and the (cylindrical) interior surface 62 of the container 12 such that the flight assembly may be inserted into or removed from the container 12 when the lid 38 is removed (or opened). The clearance may be selected so as to accommodate variations in diameter from one container 12 to another. In some embodiments, the clearance may be in the range of approximately 0.05 inch to approximately 0.3 inch or more, sufficient to accommodate variations and tolerances in drum constructions. A reasonable amount of looseness in the fit between the flight insert 16 and the inner walls container 12 is workable with the disclosed system. In some example embodiments, the flights 44, 44′ of the insert 16 will rotate with a loaded drum at least in part because of friction between the flights 44 and inner portions of the container 12. Friction may exist while the system is stationary due to the fit of the insert 16 in the container 12, and/or friction may be created between the flights 44 and inner portions of the container 12 during rotation. It is also believed that the aforementioned frictional engagement is promoted by the presence of material at the lower end portion of the container 12, which may help resist relative motion between flight assembly 16 and the container 12 during rotation of the container 12.

Referring now to FIG. 7A, in some embodiments, each flight 44, 44′ may be provided with a constant width w, such that their inner edges 50, 50′ are parallel to the outer edges 52, 52′, respectively. Accordingly, some or all of the inner edges 50, 50′ and the outer edges 52, 52′ may be elliptical. Such arrangement may promote particle flow along each flight 44, 44′ and may contribute to a symmetry of the flight insert 16 such that no matter which end (48 or 48′) of the flight assembly 16 is first inserted into the container 12, the flight assembly 16 may function in the same manner. In some embodiments, each flight 44, 44′ may be provided with a non-constant width w, such that for example, the flight may be wider around the middle of the flight and narrower at each end of the flight. Other non-constant width designs may be used.

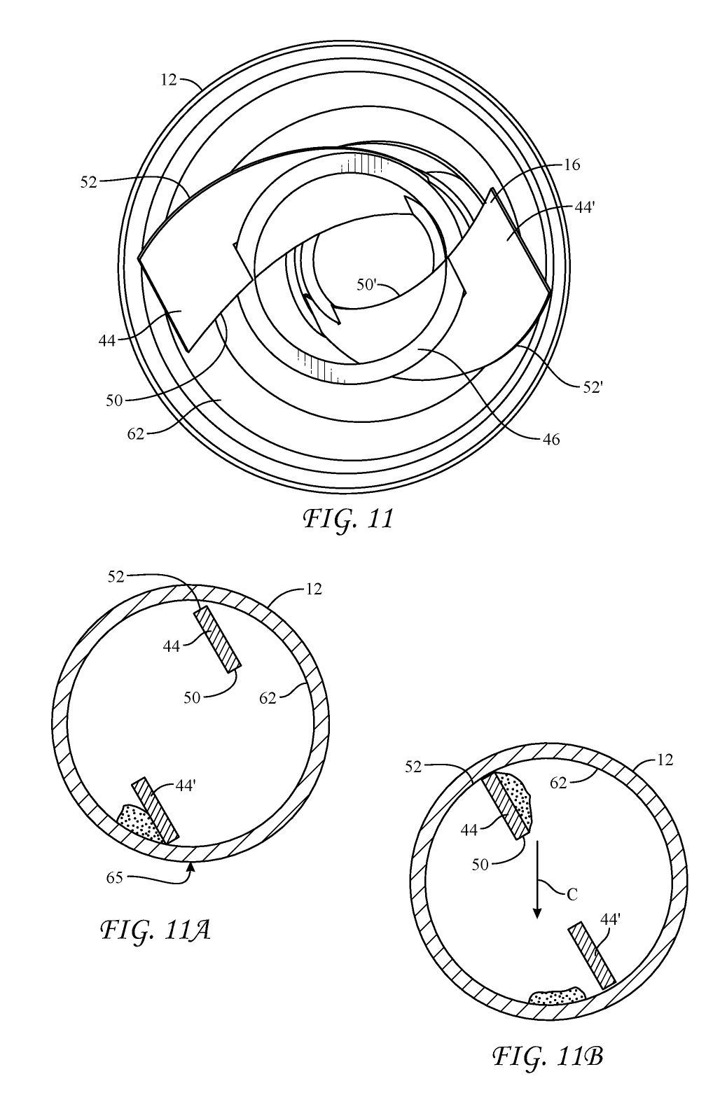

Referring now to FIGS. 8A-E, in an example embodiment, a lid component 38 of a container 12 may be opened, whereupon a flight insert 16 may be inserted axially into the container 12 through the opened, upper end portion 36. Referring now to FIG. 8B, examples of granular (powdered, fibrous) blend components A, B; or A, B, C; or A, B, C, D; etc., may be loaded into the container 12 through the open upper end portion 36 of the container 12. In other embodiments, the blend components may be loaded into the container 12 first in time and the flight assembly 16 second in time. In the latter case, the blend components may be loaded into the container 12 and the container 12 may be re-closed and sealed for storage until such time that blending operations are contemplated whereupon the container 12 may be reopened for insertion of the flight assembly 16 into the already loaded container 12. The flight assembly 16 may be inserted into an already loaded container 12 with a twisting motion consistent with the inclination of the flights 44, 44′.

Referring now to FIG. 8C, once loaded with both the blend components and the flight assembly 16, the blend components will occupy a certain percentage of the volume of the container, which may depend in some cases on the flowability of the material being mixed. It has been found to be advantageous in certain embodiments to limit the filling of the container 12 such when the container 12 is inclined upon the drum roller apparatus 14, only a small amount of material will likely place adjacent the upper end portion 36 of the container. In some embodiments, the flight assembly 16 extends longitudinally along the interior 62 of the container 12, such that the lower end 48′ may rest upon the bottom end portion 34 of the container 12, and the upper end 48 of the flight assembly 16 may be positioned adjacent the closed lid 38 of the container 12 with clearance.

Referring now to FIG. 8D, in an example embodiment, upon a loading of the container 12 with blend components A, B, etc., together with the flight insert 16 and closure of the lid 38 of the container 12, the container 12 is ready to be placed upon the drum roller apparatus 14 and rotated while in an inclined position for a sufficient time and rate to blend the components to form a blended product. In some embodiments, the loaded blend components together with an inserted flight assembly 16 may occupy approximately 50% or more of the internal volume of the container 12. In other embodiments, the loaded blend components together with an inserted flight assembly 16 may occupy less than approximately 50%, which may promote mixing action. For example, in an example embodiment utilizing a 55 gallon drum, the batch may be less than approximately 30 gallons, or 25 gallons or fewer. In a different example, the batch may be more than 30 gallons. Different drum sizes and amount of blend components may be used depending on the application.

In example embodiments, during the aforementioned blending operation, the flight assembly 16 rotates at the same speed of the container 12, blending the blend components A, B, etc. It is believed that, in certain embodiments, rotation of the container 12 is communicated to the flight assembly 16 through frictional engagement between the flight assembly 16 and the interior surfaces 62 of the container 12. In certain embodiments with clearances between the flight assembly 16 and interior 62 of the container 12, there may be a tendency of the flight assembly 16 to bear against the interior 62 of the container 12 along a lower side portion 64 of the container 12 when the container 12 is inclined on the drum roller apparatus 14. It is also believed that this bearing action helps frictionally engage the flight assembly 16 with the interior 62 of the container 12 so that the flight assembly 16 and the container 12 rotate together.

If desired, a suitable mechanical connection between the flight assembly 16 and the container 12 may be employed to communicate the rotational motion of the container 12 to the flight assembly 16.

Referring now to FIG. 8E, in example embodiments, upon completion of the blending operation, the container 12 may be removed from the drum roller apparatus 14 and sent to storage for opening and unloading at a later time. In other embodiments, the container 12 may be opened at the end of the blending operation so that the blended product may be removed and/or the flight assembly 16 may be removed from the container 12 for immediate reuse in another blending operation. The blended product may also be retained in the container 12 and sealed for storage.

Referring now to FIGS. 9, 10 and 10A, during a blending operation, flights 44, 44′ may rotate clockwise into a position (counterclockwise location may also be used), which if it were viewed from the side, would correspond to the image presented in FIG. 9, wherein each flight 44, 44′ is longitudinally inclined with respect to an external horizontal plane and wherein the planes of the flights 44, 44′ appear to cross (intersect) at an intermediate location along the longitudinal axis of the container 12 (and at an intermediate location along the axis 54 of the flight assembly 16). As shown in FIG. 10A, in an example embodiment, the first flight 44 has already rotated through the lower (6 o'clock) position (at designation 65 in FIG. 10A) to pick up and then lift particles therefrom.

In an example embodiment, the relative positions of three cross-sections of the first flight 44 as one progresses from FIG. 10A to FIG. 10B to FIG. 10C exhibit the inclination of the first flight 44, upon which there may be a quantity of lifted particles 102. Those particles may be induced by gravity to flow down the inclined first flight 44. As indicated by the arrow designated “c”, some of this material may begin to cascade off the inner edge 50 of the flight 44 as the particles slide down the incline of the flight 44. The particles cascading off the inner edge 50 may fall to and may be captured by interior portions 104 of the rotating container 12 around the 6 o'clock position 65, which action may be facilitated by a gap 106 created by the curvature of the flights 44 and 44′ and the opposing angles of the flights (as shown, for example, in FIGS. 3 and 4).

It is noted that during the time that the first flight 44 may rotate in the direction of arrow r through the 6 o'clock position and arrives at the position shown in FIG. 10, the particles being lifted may also be initially urged toward the outer edge 52 of the first flight 44 by the cant of the first flight 44 relative to an external horizontal plane and from rotation of container 12 and the flight assembly 16. Thereafter, while rotating beyond the position shown in FIG. 10, the flight 44 may cant relative to an external horizontal plane, such that the flow of lifted particles may include a longitudinal flow along the flight (as shown in FIG. 9) and a radially inward flow component toward the inner edge 50 of the flight. The canting and the consequential radially inward flow component may continue to increase as the first flight 44 rotates into the positions shown in FIG. 11 and then into the position shown in FIG. 12. At the latter position (of FIG. 12), the first flight 44 is canted vertically and essentially all lifted particles may have already cascaded off the inner edge 50 of the first flight 44.

Referring back to FIGS. 10 A-C, in an example embodiment, the second flight 44′ is inclined in the opposite direction than flight 44 and may be essentially free of particles, due in at least in part to the flight 44′ having rotated beyond the upper, 12 o'clock position 66 about the rotating container 12. As show in FIG. 10A, adjacent the lower end portion 34 of the container 12, the lower section of the second flight 44′ may be approaching the 6 o'clock position 65, where it will begin to scoop and lift particles as it rotates through the 6 o'clock position.

Referring now to FIGS. 11 and 11 A-C, in an example embodiment, as the flights 44, 44′ rotate approximately an additional 45°, the first flight 44 is canted relative to an external horizontal plane so as to promote cascading of particles off the inner edge 50 of the flight 44. Such action helps overcome the tendency of the particles by their own inertia (or centrifugal force) to move radially outwardly toward the interior surface 62 of the container 12 (toward the outer edge 52 of the flight 44). At this point, the lower section of the second flight 44′ has reached the 6 o'clock position 65 where it picks up and lift particles therefrom.

Referring now to FIGS. 12 and 12 A-C, in an example embodiment, as the flights 44, 44′ rotate approximately an additional 45°, the first flight 44 may have achieved an orthogonal relation a horizontal plane such that the particles will likely have cascaded off the flight 44 under the influence of gravity. Rotation through this orientation may also tend to clear any particles caught at the juncture between the rings 46, 46′ and the flight 44. The second flight 44′ continues to progress into picking up particles (and upon further rotation, eventually cascading particles off its inner edge 50′) in a manner as previously explained for the first flight 44.

In an example embodiment, particles which cascade off the inner edges 50, 50′ of the flights 44, 44′ during rotation, respectively, may fall to the interior portion 104 of the container 12 which may be rotating through the 6 o'clock position 65 at that time. In an example embodiment, because of inclination of the container 12 while being rotated from roller apparatus 14, at least some of the cascaded material returns (recirculates) to the bottom portion 34 of the container 12 whereat it may be again lifted by action of flights 44, 44′ as previously described.

Referring to FIG. 9, several aspects of example embodiments are shown to blend components. Those aspects may include some or all of the following:

rotation of flights 44, 44′, which are inclined to induce a particle flow from the lower end portion 34 of the container 12 toward its upper end portion 36 during certain portions of the rotation, as represented for flight 44 by an arrow d in FIG. 9;

rotation of the flights 44, 44′ such that a flight which has lifted particles may cant such that particle flow may cascade off an inner edge 50, 50′ of the respective flight 44, 44′;

recirculation of cascaded particles from along a bottom portion of the rotating container 12 back toward the lower end portion 34 of the container 12 (as represented by the arrow “rec” in FIG. 9); and/or

ability to readily remove the flight assembly 16 from container 12, in some cases to facilitate, for example, cleaning, inspection, etc.

Referring now to FIG. 13, in an embodiment, the flights 44″, 44′″ may be provided with rims 103, 103′ which may extend along their respective inner edges 50, 50′ or along portions thereof. The inner rims 103,103′ may extend orthogonally or at an angle to the general plane of the flights 44″, 44′″ and may extend from the sides 104,104′ of the flights 44″,44″, respectively, that primarily contact the granular material during rotation. The inner rims 103, 103′ may be utilized to delay spillage (the cascading) of material off the inner edges 50, 50′. In other example embodiments, the inner rims 103, 103′ may be provided on both sides of each of the flights 44″, 44′″, such that they extend not only from the sides 104, 104′ that primarily contact the granular material, but also the other sides as well.

Referring now to FIG. 14, in another embodiment, any of the previously described flights 44 may be provided with a plurality of perforations 106 at one or more zones X, Y, etc. along the flight to promote release of granular material. In the embodiment shown in FIG. 14, the entire flight has perforations, but in another embodiment, there may be three zones X, Y, Z, and zones X and Z at opposite ends of the flight 44″ may be provided with perforations 106, whereas the intermediate zone Y may be free of perforations 106. The opposite arrangement might prove useful in other applications. Any number of zones may be used and different combinations of perforations. Additionally, the perforations 106 may have size, form and/or pattern other than what is specifically shown, such as slots or the like. Also, the size and/or number of the perforations 106 may differ from zone to zone or within a zone.

One or more of the embodiments described herein may be particularly suited for blending multiple solid (granular, powdered, and/or fibrous) ingredients into a blended product. Reference to granules, granular materials, particles and/or particulate materials herein is inclusive of all forms of flowable materials such as particles, granules, powders, beads, capsules, micro-capsules, nodules, fibers, fibrils, nano-particles, etc., and any other dry, solid, or other form that may be caused to flow along an incline.

It is also contemplated that the teachings herein may also be applied for effective mixing of components of an aqueous solution or suspension.

It is contemplated that the teachings herein may be applied to apparatus and methods, wherein the flight assembly 16 comprises a single flight 44, a pair of flights 44, 44′ or more than two flights, such as three or four flights or more.

It is also contemplated that the teachings herein may be applied to containers of any rotatable shape, of which a cylindrical shape is just an example. For example, the container could be conical or of a polygonal cross-section or other shape.

It is further contemplated that the inner edges 50, 50′ and/or the outer edges 52, 52′ of the flights 44, 44′ may be rounded, beveled or have some other form other than what is specifically shown in the figures and they need not be continuous as shown, but may instead include notches, recesses or the like.

### PCT

Illustrative, additional non-exclusive examples of apparatus and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

PCT 1. A flight assembly comprising: a flight comprising a curved outer edge portion; a support supporting the flight at an acute angle with respect to a longitudinal axis of the flight assembly; the curved outer edge portion when rotated about the longitudinal axis describing a cylinder.

PCT 2. The flight assembly of PCT 1, wherein the curved outer edge portion of the flight is elliptical.

PCT 3. The flight assembly of PCT 1 or 2, wherein the flight is planar and/or has a constant width.

PCT 4. The flight assembly of any of PCT 1, 2 or 3, wherein the flight is a first flight, and the flight assembly further comprises a second flight comprising a curved outer edge portion.

PCT 5. The flight assembly of any of PCT 1-4, wherein the support supports the first and second flights in a mutually complementary angular relation.

PCT 6. The flight assembly of any of PCT 1-5, wherein the support comprises a first ring spaced apart from a second ring.

PCT 7. The flight assembly of any of PCT 1-6, wherein the first and second flights are mutually arranged to provide an end-to-end symmetry such that the flight assembly is operative regardless of which end of the flight assembly is located at a bottom of the container.

PCT 8. The flight assembly of any of PCT 1-7, wherein respective planes of the first and second flights intersect at an intermediate location along the flight assembly.

PCT 9. The flight assembly of any of PCT 1-8, wherein the flight includes perforations.

PCT 10. The flight assembly of any of PCT 1-9, wherein the flight includes a rim extending from an inner edge portion of the flight.

PCT 11. The flight assembly of any of PCT 1-10, wherein the container is cylindrical and wherein from a top view, a curvature of the curved outer edge portion of the flight is generally parallel to a curvature of an interior surface of the container.

PCT 12. A mixing drum comprising the flight assembly of any of PCT 1-11 and a cylindrical drum body, wherein from a top view, a curvature of the curved outer edge portion of the flight is generally parallel to a curvature of an interior surface of the cylindrical drum body.

PCT 13. A system for blending materials, the system comprising: a cylindrical drum body; the flight assembly of any of PCT 1-11 within an interior of the cylindrical drum body; a drum roller apparatus arranged and configured to support and rotate the cylindrical drum body at an angle of inclination with respect to the horizontal.

PCT 14. The system of PCT 13, wherein the angle of inclination of the drum roller apparatus is less than the acute angle such that the flight is rotatable through an orientation wherein a plane of the flight is inclined downwardly.

PCT 15. The system of PCT 13, wherein the flight assembly slideably fits within an interior of the cylindrical drum body and wherein the rotation of the drum body is frictionally communicated to the flight assembly in an absence of a mechanical connection between the drum body and the flight assembly.

PCT 16. A method of blending materials comprising: opening a container; inserting a flight assembly into the container, the flight assembly comprising a flight arranged such that upon insertion of the flight assembly into the container a lower section of the flight positions adjacent to or close to a lower end portion of the container and an upper section of the flight positions adjacent to or close to an upper end portion of the container, upon insertion of the flight assembly into the container a plane of the flight is disposed at an acute angle with respect to a longitudinal axis of the container; loading materials into the container; closing the container; and rotating the loaded container while maintaining the loaded container at an angle, such that as the container rotates the flight assembly rotates with the container, and such that during rotation: the lower section of the flight repetitively lifts a portion of the materials from the lower end portion of the container; the flight repetitively distributes lifted materials along an interior of the container, including by cascading lifted materials off an inner edge of the flight as lifted materials flow from the lower section of the flight toward the upper section of the flight; and the interior of the container repeatedly returns cascaded materials to the lower portion of the container.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A flight assembly comprising:
a flight comprising a curved outer edge portion;
a support supporting the flight at an acute angle with respect to a longitudinal axis of the flight assembly;
the curved outer edge portion when rotated about the longitudinal axis describing a cylinder.

2. The flight assembly of claim 1, wherein the curved outer edge portion of the flight is elliptical.

3. The flight assembly of claim 1, wherein the flight is planar.

4. The flight assembly of claim 1, wherein the flight has a constant width.

5. The flight assembly of claim 1, wherein the flight is a first flight, and the flight assembly further comprises a second flight comprising a curved outer edge portion.

6. The flight assembly of claim 5, wherein the support supports the first and second flights in a mutually complementary angular relation.

7. The flight assembly of claim 5, wherein the support supports the first flight and the second flight such that the flight assembly is self-supporting.

8. The flight assembly of claim 1, wherein the support comprises a ring.

9. The flight assembly of claim 1, wherein the support comprises a first ring spaced apart from a second ring.

10. The flight assembly of claim 5, wherein flight assembly is located inside a container and wherein the first and second flights are mutually arranged to provide an end-to-end symmetry such that the flight assembly is operative regardless of which end of the flight assembly is located at a bottom of the container.

11. The flight assembly of claim 5, wherein respective planes of the first and second flights intersect at an intermediate location along the flight assembly.

12. The flight assembly of claim 1, wherein the flight includes perforations.

13. The flight assembly of claim 1, wherein the flight includes a rim extending from an inner edge portion of the flight.

14. The flight assembly of claim 1, the flight further comprising a curved inner edge portion.

15. The flight assembly of claim 1, wherein the flight assembly is located inside a cylindrical container.

16. The flight assembly of claim 1, wherein the flight is a first flight, and the flight assembly further comprises a second flight comprising a curved outer edge portion, the support supporting the second flight such that the first and second flights form an X-shape from a side view.

17. The flight assembly of claim 15, wherein from a top view, a curvature of the curved outer edge portion of the flight is generally parallel to a curvature of an interior surface of the container.

18. A mixing drum, comprising:
a cylindrical drum body;
a flight assembly within an interior of the cylindrical drum body, the flight assembly comprising:
a flight comprising a curved outer edge portion;
a support supporting the flight at an acute angle with respect to a longitudinal axis of the cylindrical drum body;
wherein from a top view, a curvature of the curved outer edge portion of the flight is generally parallel to a curvature of an interior surface of the cylindrical drum body.

19. The mixing drum of claim 18, wherein the flight is a first flight, and the flight assembly further comprises a second flight comprising a curved outer edge portion.

20. The mixing drum of claim 19, wherein the support supports the first and second flights in a mutually complementary angular relation.

21. The mixing drum of claim 19, wherein the first and second flights are planar.

22. The mixing drum of claim 19, wherein the curved outer edge portions of the first and second flights are elliptical.

23. The mixing drum of claim 19, wherein the first and second flights have a constant width.

24. The mixing drum of claim 19, wherein the support supports the first flight and the second flight such that the flight assembly is self-supporting.

25. The mixing drum of claim 18, wherein the support comprises a ring.

26. The mixing drum of claim 18, wherein the support comprises a first ring spaced apart from a second ring.

27. The mixing drum of claim 19, wherein the first and second flights are mutually arranged to provide an end-to-end symmetry such that the flight assembly is operative regardless of which end of the flight assembly is at a bottom of the drum body.

28. The mixing drum of claim 19, wherein respective planes of the first and second flights intersect at an intermediate location along the drum body.

29. The mixing drum of claim 18, wherein the flight includes perforations.

30. The mixing drum of claim 18, wherein the flight includes a rim extending from an inner edge portion of the flight.

31. The mixing drum of claim 18, wherein the flight further comprises a curved inner edge portion.

32. The mixing drum of claim 18, wherein the flight is a first flight, and the flight assembly further comprises a second flight comprising a curved outer edge portion, the support supporting the second flight such that the first and second flights form an X-shape from a side view.

33. A system for blending materials, the system comprising:
a cylindrical drum body;
a drum roller apparatus arranged and configured to support and rotate the cylindrical drum body at an angle of inclination with respect to the horizontal;
a flight assembly within an interior of the cylindrical drum body, the flight assembly comprising:
a flight comprising a curved outer edge portion;
a support supporting the flight at an acute angle with respect to a longitudinal axis of the cylindrical drum body.

34. The system of claim 33, wherein the angle of inclination of the drum roller apparatus is less than the acute angle such that the flight is rotatable through an orientation wherein a plane of the flight is inclined downwardly.

35. The system of claim 33, wherein the flight assembly slideably fits within an interior of the cylindrical drum body.

36. The system of claim 33, wherein the rotation of the drum body is frictionally communicated to the flight assembly in an absence of a mechanical connection between the drum body and the flight assembly.

37. The system of claim 33, wherein the flight is planar.

38. The system of claim 33, wherein the outer edge and an inner edge of the flight are elliptical.

39. The system of claim 33, wherein the curved outer edge portion of the flight approximately coincides with an inner diameter of the drum body at an intermediate location along the drum body.

40. The system of claim 33, wherein the flight is a first flight, and the flight assembly further comprises a second flight comprising a curved outer edge portion.

41. The system of claim 40, wherein the support supports the first and second flights in a mutually complementary angular relation.

42. The system of claim 40, wherein the support supports the first flight and the second flight such that the flight assembly is self-supporting.

43. The system of claim 33, wherein the support comprises a first ring spaced apart from a second ring.

44. The system of claim 40, wherein the first and second flights are mutually arranged to provide an end-to-end symmetry such that the flight assembly is operative regardless of which end of the flight assembly is at a bottom of the cylindrical drum body.

45. The system of claim 33, wherein the flight includes perforations.

46. The system of claim 33, wherein the flight includes a rim extending from an inner edge portion of the flight.

47. The system of claim 33, wherein the drum roller apparatus includes a base portion operative to support a lower end portion of the drum body, the base portion comprising a low-friction plate, a rotatable plate, or a low-friction rotatable plate.

48. The system of claim 33, wherein the flight assembly and the cylindrical drum body are attached.

49. The system of claim 40, wherein respective planes of the first and second flights intersect at an intermediate location along the flight assembly.

50. The system of claim 33, wherein the flight is a first flight, and the flight assembly further comprises a second flight comprising a curved outer edge portion, the support supporting the second flight such that the first and second flights form an X-shape from a side view.

51. A method of blending materials comprising:
opening a container;
inserting a flight assembly into the container, the flight assembly comprising a flight arranged such that upon insertion of the flight assembly into the container a lower section of the flight positions adjacent to or close to a lower end portion of the container and an upper section of the flight positions adjacent to or close to an upper end portion of the container, upon insertion of the flight assembly into the container a plane of the flight is disposed at an acute angle with respect to a longitudinal axis of the container;
loading materials into the container;
closing the container; and
rotating the loaded container while maintaining the loaded container at an angle, such that as the container rotates the flight assembly rotates with the container, and such that during rotation:
the lower section of the flight repetitively lifts a portion of the materials from the lower end portion of the container;
the flight repetitively distributes lifted materials along an interior of the container, including by cascading lifted materials off an inner edge of the flight as lifted materials flow from the lower section of the flight toward the upper section of the flight; and
the interior of the container repeatedly returns cascaded materials to the lower portion of the container.
